(19) United States
(12) Patent Application Publication
(10) Pub. No.: US 2011/0057631 A1
(43) Pub. Date: Mar. 10, 2011

(54) STATIC EXCITER OF AN ELECTRIC GENERATOR, METHOD FOR RETROFITTING, AND METHOD FOR OPERATING

(76) Inventor: Luca Dalessandro, Zurich (CH)

(21) Appl. No.: 12/861,253

(22) Filed: Aug. 23, 2010

(30) Foreign Application Priority Data
Sep. 7, 2009 (EP) 09169645.0

(51) Int. Cl. H02P 9/08

(52) U.S. Cl. 322/60

(57) ABSTRACT

The static exciter (1) of an electric generator (2) has a main transformer (8) with a high voltage side connected to the grid (5) and a low voltage side connected to a field circuit converter (9) that feeds a generator field circuit (3). The static exciter (1) includes a control unit (11) arranged to detect the status of the grid (5) to cause at least a capacitor bank (13) to supply energy to said generator field circuit (3) in case the voltage of the grid (5) falls below a prefixed voltage value. The capacitor bank (13) is connected between the low voltage side of the main transformer (8) and the AC side of the field circuit converter (9).

This application claims priority under 35 U.S.C. §119 to European application no. 09169645.0, filed 7 Sep. 2009, the entirety of which is incorporated by reference herein.

### BACKGROUND

1. Field of Endeavor

The present invention relates to a static exciter of an electric generator, a method for retrofitting, and a method for operating the same.

2. Brief Description of the Related Art

Electric synchronous generators include a stator typically having an armature circuit and a rotor typically hosting a field circuit.

During operation, while the rotor rotates, the field circuit is energized such that electric voltage is induced in the armature circuit, due to the flux rate of change.

In order to energize the field circuit, usually a transformer is connected to the grid (or busbar) at its high voltage side and has its low voltage side connected to an AC/DC converter.

This AC/DC converter rectifies the AC voltage supplied from the transformer into DC voltage and supplies it to the field circuit of the generator.

Since the electric power for feeding the field circuit is directly supplied from the grid, in case a failure or disturbance at the grid occurs, causing the voltage at the grid to temporary fall, the stability of the generator/grid system may be compromised such that grid and generator may lose their synchronization.

Electric grids are often provided with automatic security and protection systems that intervene when such failures occur to restore the nominal grid voltage; nevertheless it usually takes up to some seconds to restore the grid voltage, thus the stability of the generator/grid system cannot be guaranteed if a failure occurs.

U.S. Patent Application Publication No. 2007/0296275 discloses providing a security circuit arranged to inject electric power into the field circuit in case a failure at the grid occurs, to guarantee the stability of the generator/grid system and to prevent losing synchronization.

This security circuit includes a capacitor bank, a switch to be activated in case of grid failure, and a diode to be directly inserted into the field circuit (i.e., this diode must be placed on the rotor).

In case a failure at the grid occurs, the switch is activated such that the capacitor bank supplies its energy into the field circuit.

Nevertheless, even if this technique proved to be very efficient, its implementation may be difficult, costly and time-consuming in some cases, since it requires the diode to be placed on the rotor.

In particular, retrofitting of existing electric generators is difficult because the generator casing must be opened and the diode must be installed on the rotor.

This operation is particularly time consuming and costly.

### SUMMARY

One of numerous aspects of the present invention includes a static exciter, a method for retrofitting, and a method for operating a static exciter by which the aforementioned problems of the known art are addressed.

Another aspect of the present invention includes a static exciter and a method for operating the same that can be easily, cost-efficiently, and time-efficiently implemented.

Another aspect includes a retrofitting method that can be easily, cost-efficiently, and time-efficiently implemented.

### BRIEF DESCRIPTION OF THE DRAWINGS

Further characteristics and advantages of the invention will be more apparent from the description of a preferred but non-exclusive embodiment of the static exciter and methods according to the invention, illustrated by way of non-limiting example in the accompanying drawings, in which:

FIG. 1 is a schematic view of the static exciter in a first embodiment of the invention;

FIG. 2 illustrates a detail of a second embodiment of the static exciter of the invention;

FIG. 3 illustrates a third embodiment of the static exciter of the invention; and

FIG. 4 illustrates a detail of FIG. 3.

### DETAILED DESCRIPTION OF EXEMPLARY EMBODIMENTS

With reference to the figures, a static exciter 1 of an electric generator 2 is illustrated.

The electric generator 2 has a field circuit 3 and a busbar 4 (stator three-phase circuit) connected to an electric grid 5 via a transformer 6.

The static exciter 1 includes a main transformer 8 having its high voltage side connected to the grid 5 (typically, as shown in the figures, the main transformer 8 is directly connected to the busbar 4 and is connected to the grid 5 via the transformer 6) and its low voltage side connected to a field circuit converter 9 (typically a rectifier).

The field circuit converter 9 converts the AC voltage from the main transformer 8 and feeds the generator field circuit 3 with a DC voltage.

The static exciter 1 further includes a control unit 11 arranged to detect the status of the grid 5 to cause at least a capacitor bank 13 to supply energy into the generator field circuit 3 in case the grid voltage falls below a prefixed voltage value.

The capacitor bank 13 is connected between the low voltage side of the main transformer 8 and the AC side of the field circuit converter 9.

Advantageously, the static exciter also includes at least a coupling circuit 15 connecting the capacitor bank 13 to connection lines 16 between the low voltage side of the main transformer 8 and the AC side of the field circuit converter 9.

In the following, different embodiments embodying principles of the present invention will de described in detail.

### Embodiment 1

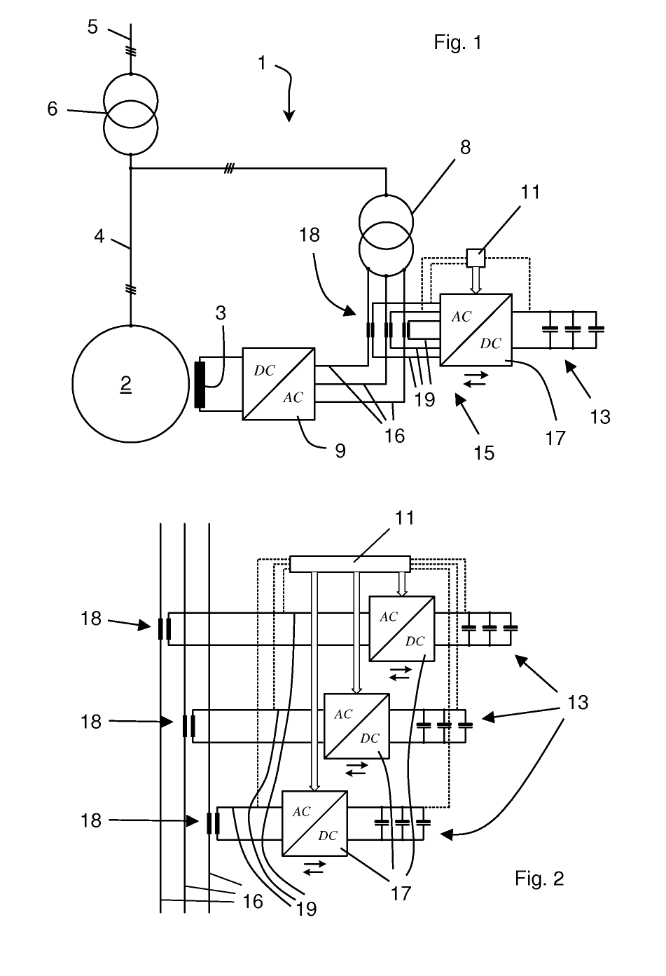

In a first embodiment of the static exciter 1 (FIG. 1), the coupling circuit 15 includes an auxiliary three-phase converter 17 having a DC side connected to the capacitor bank 13 and an AC side coupled to the connection lines 16.

Preferably the auxiliary converter 17 is a bidirectional converter, such that charging and discharging of the capacitor bank 13 is allowed.

For example, the auxiliary converter 17 is made of a power semiconductor element bridge (IGBT, thristors); in any case these converters are well known in the art and any suitable converter or power semiconductor element disposition may be used.

The AC side of the auxiliary converter 17 is inductively coupled to the connection lines 16 and, in this respect, the inductive coupling is realized via an auxiliary transformer 18.

In this embodiment of the invention, the control unit 11 is connected to at least two auxiliary connection lines 19. Naturally a connection also to all three auxiliary connection lines 19 may be provided and, in case of different configuration, for example more or less than three phases, more or less than two connections may be provided.

In addition, the control unit 11 is connected to the auxiliary converter 17 to drive it.

The control unit 11 detects the voltage of the auxiliary connection lines 19 between the auxiliary converter 17 and the auxiliary transformer 18 and drives the auxiliary converter 17 accordingly.

In particular, the control unit 11 drives the auxiliary converter 17 such that it lets the capacitor bank 13 be discharged or charged.

The control unit 11 is also connected to the capacitor bank 13 to control its charging level.

The operation of the static exciter in this embodiment is apparent from that described and illustrated and is substantially the following.

During normal operation (with the voltage grid at its nominal value) the control unit 11 drives the auxiliary converter 17 such that it lets the electric power pass through it from the auxiliary transformer 18 to the capacitor bank 13.

In this situation the capacitor bank 13 is charged, such that in case of failure it is always charged and ready to discharge its energy into the field circuit 3.

When at the grid 5 a failure occurs, the grid voltage falls and, thus, the busbar voltage also falls and the voltage at the low voltage side of the main transformer 8 falls; this causes also the voltage at the auxiliary connection lines 19 to fall.

When the control unit 11 detects that the voltage at the auxiliary connection lines 19 has fallen below a prefixed voltage value, it drives the auxiliary converter 17 such that it allows the electric power to pass through it, from the capacitor bank 13 to the auxiliary transformer 18.

This causes the capacitor bank 13 to be discharged and its energy to be provided, through the auxiliary converter 17 and auxiliary transformer 18, to the connection lines 16 and thus, through the field circuit converter 9, to the field circuit 3.

As known in the art, when a failure at the grid 5 occurs, a number of automatic protection and control systems intervene to restore the grid voltage; usually restoration of the grid voltage is carried out in few seconds.

Therefore, as soon as the grid voltage is restored (thus also the auxiliary connection line voltage is restored) the control unit 11 drives the auxiliary converter 17 such that it allows electric power to pass though it from the auxiliary transformer 18 to the capacitor bank 13 again.

Thus the capacitor bank 13 is charged to be ready to intervene in case of further grid failures.

### Embodiment 2

FIG. 2 shows a second embodiment of the static exciter embodying principles of the present invention. In FIG. 2 elements similar or the same as those already described with reference to the first embodiment have the same references.

The static exciter in the second embodiment has the same structure and features of that of the first embodiment.

In addition, this static exciter has three capacitor banks 13 each connected to an auxiliary single phase converter 17 connected to an auxiliary transformer 18 coupled to a connection line 16 between the main transformer 8 and the field circuit converter 9; moreover, a control unit 11 for each auxiliary converter 17 is provided or, alternatively, a single control unit 11 controlling independently each auxiliary converter 17 is provided (this embodiment is shown in FIG. 4).

In other words, the static exciter has one electric power injection circuit for each phase (each electric power injection circuit including a capacitor bank 13, an auxiliary converter 17, and an auxiliary transformer 18), whereas the embodiment of FIG. 1 has only one three-phase electric power injection circuit.

The operation of the static exciter in this embodiment is clear in particular in light of the operation of the static exciter of the first embodiment.

### Embodiment 3

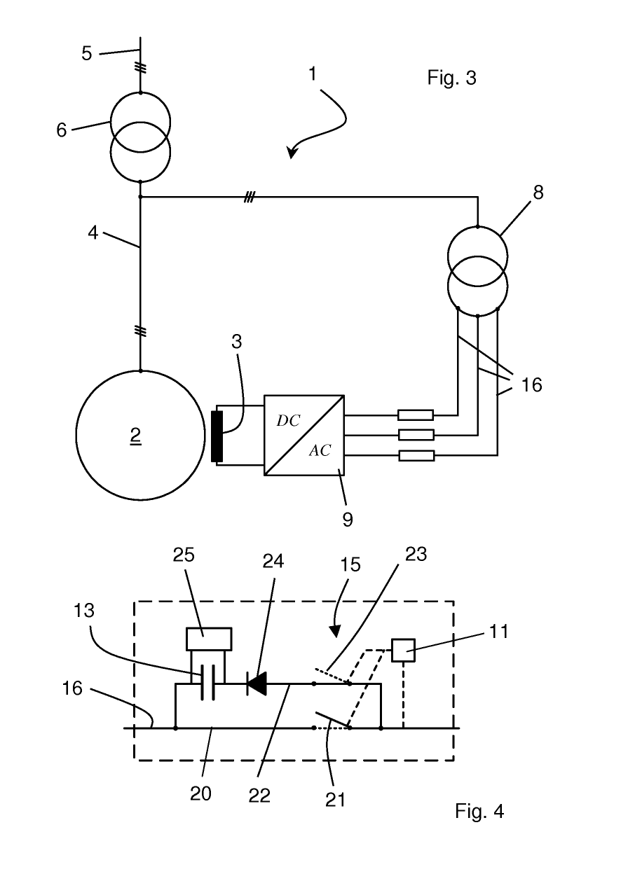

FIGS. 3 and 4 show a third embodiment of the static exciter 1 embodying principles of the present invention. Also in these figures, elements similar or the same as those already described have the same references.

In particular, in FIG. 3 the main transformer 8 and the field circuit converter 9 are shown connected by connection lines 16.

Each connection line 16 has a first branch 20 (FIG. 4) with a first switch 21 and the coupling circuit 15 comprises a second branch 22 in parallel with the first branch 20.

The second branch 22 has a second switch 23 in series with a one-way component 24; also the capacitor bank 13 is series with these components.

The control unit 11 (also in this case a single control unit 11 for each connection line 16 or a single control unit 11 that independently controls the switches 21, 23 of each connection line 16) is connected to the respective connection line 16 and, in addition, drives the switches 21 and 23, i.e., it detects the voltage of the connection line 16 and operates the first and second switches 21, 23 accordingly.

The one-way component 24 can be a diode arranged to cause the capacitor bank 13 to supply energy to the field circuit 3 when it is discharged.

In addition, also a charging component 25 such as a battery or the like in parallel with the capacitor bank 13 may be provided.

It is anyhow clear that (thanks to the diode 24) charging of the capacitor bank 13 may also be carried out during operation via the branch 22 (i.e., with switch 21 open and switch 23 closed) in case there is no fault at the grid 5 and the voltage at the connection lines 16 has its nominal value.

The operation of the static exciter 1 in the third embodiment of the invention is apparent from what described and illustrated and is substantially the following.

During normal operation (i.e., the grid voltage is at its nominal value) the switch 21 is closed (dashed line in FIG. 4) whereas the switch 23 is open (dashed line in FIG. 4); therefore during normal operation the branch 20 is operative whereas the branch 22 is not operative.

When a failure occurs and the grid voltage falls, also the voltage at the low voltage side of the main transformer 8 falls and, thus, the voltage of one or more of the connection lines 16 falls.

With reference to only one connection line (the operation is the same for each connection line) when the control unit 11 detects that the voltage of the connection line 16 (that is indicative of the voltage of the grid 5) falls below a prefixed voltage value, it drives the switch 21 to open, and the switch 23 to close.

In this respect, FIG. 4 shows in full line the configuration of the switch 21 and the switch 23 in case of failure with grid voltage drop; therefore, in case of failure the branch 20 is not operative and the branch 22 is operative.

When the switch 23 is closed, the capacitor bank 13 is discharged and the diode 24 forces the discharge direction, such that electric power is injected into the field circuit converter 9 and thus into the field circuit 3; the switch 21 (that is open) prevents the capacitor bank 13 from being short-circuited.

After a failure, the automatic security and protection systems restore the grid voltage in a short time.

When the control unit 11 detects that the voltage at the connection line 16 is above the prefixed voltage value, it drives the switch 21 to close and the switch 23 to open.

Closing of switch 21 and opening of switch 23 may also be carried out by the control unit 11 with a delay, such that the capacitor bank 13 is charged.

In addition or alternatively, the charging component 25 may charge the capacitor bank 13.

Method for Retrofitting

The present invention also refers to methods for retrofitting a static exciter of an electric generator.

Exemplary methods include providing at least one capacitor bank 13 between the low voltage side of the main transformer 8 and the AC side of the field circuit converter 9.

Advantageously, also providing a coupling circuit 15 connecting the capacitor bank 13 to connection lines 16 between the low voltage side of the main transformer 8 and the AC side of the field circuit converter 9 is provided.

This retrofitting method is particularly advantageous because there is no need of modifying the rotor and, thus, there is no need of opening the generator casing and installing any component aboard of the rotor.

Method for Operating a Static Exciter

The present invention also refers to methods for operating a static exciter of an electric generator.

According to exemplary methods, the capacitor bank 13 injects electric power between the low voltage side of the main transformer 8 and the AC side of the field circuit converter 9 when the grid voltage falls below a prefixed voltage value.

Naturally the features described may be independently provided from one another.

In practice the materials used and the dimensions can be chosen at will according to requirements and to the state of the art.

### REFERENCE NUMBERS

1 static exciter
2 electric generator
3 field circuit
4 busbar
5 electric grid
6 transformer
8 main transformer
9 field circuit converter
11 control unit
13 capacitor bank
15 coupling circuit
16 connection line
17 auxiliary converter
18 auxiliary transformer
19 auxiliary connection line
20 first branch
21 first switch
22 second branch
23 second switch
24 one-way component
25 charging component

While the invention has been described in detail with reference to exemplary embodiments thereof, it will be apparent to one skilled in the art that various changes can be made, and equivalents employed, without departing from the scope of the invention. The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

I claim:

1. A static exciter of an electric generator comprising:
a main transformer having a high voltage side configured and arranged to be connected to a grid, and a low voltage side;
a generator field circuit;
a field circuit converter having an AC side, connected between the main transformer low voltage side and the generator field circuit;
a capacitor bank; and
a control unit configured and arranged to detect the status of the grid to cause at least the capacitor bank to supply energy to said generator field circuit in case the voltage of the grid falls below a predetermined voltage value;
wherein the capacitor bank is connected between the low voltage side of the main transformer and the AC side of the field circuit converter.

2. A static exciter as claimed in claim 1, further comprising:
connection lines between the low voltage side of the main transformer and an AC side of the field circuit converter; and
a coupling circuit connecting the capacitor bank to the connection lines.

3. A static exciter as claimed in claim 2, wherein the coupling circuit comprises an auxiliary converter having a DC side connected to the capacitor bank and an AC side coupled to the connection lines.

4. A static exciter as claimed in claim 3, wherein the auxiliary converter comprises a bidirectional converter.

5. A static exciter as claimed in claim 3, wherein the AC side of the auxiliary converter is inductively coupled to the connection lines.

6. A static exciter as claimed in claim 5, further comprising:
an auxiliary transformer inductively coupling the AC side of the auxiliary converter to the connection lines.

7. A static exciter as claimed in claim 6, further comprising:
an auxiliary connection line between the auxiliary converter and the auxiliary transformer; and
wherein the control unit is configured and arranged to detect the voltage of at least the auxiliary connection line and drive the auxiliary converter based on said auxiliary connection line voltage.

8. A static exciter as claimed in claim 7, wherein the control unit is configured and arranged to drive the auxiliary converter so that the capacitor bank is charged or discharged.

9. A static exciter as claimed in claim 4, wherein the control unit is configured and arranged to drive the auxiliary converter so that the capacitor bank is charged or discharged.

10. A static exciter as claimed in claim 3, further comprising:
for each connection line, a capacitor bank, an auxiliary converter, and an auxiliary transformer, each capacitor bank connected to an auxiliary converter, each auxiliary converter connected to an auxiliary transformer, and each auxiliary transformer coupled to a connection line.

11. A static exciter as claimed in claim 2, wherein:
each connecting line comprises a first branch with a first switch;
the coupling circuit comprises a second branch in parallel with the first branch, the second branch having in series at least a second switch and at least a one-way component;
the capacitor bank is connected to the second branch; and
the control unit is configured and arranged to detect the voltage of the connection line and to operate the first and second switches based on said connection line voltage.

12. A static exciter as claimed in claim 11, wherein the one-way component comprises a diode arranged to cause the capacitor bank to supply energy to the field circuit when the capacitor bank is discharged.

13. A static exciter as claimed in claim 11, further comprising a charging component in parallel with the capacitor bank; or
wherein the control unit is configured and arranged to close the first switch and open the second switch with a delay, such that the capacitor bank is charged; or
both.

14. A method for retrofitting a static exciter of an electric generator, the static exciter having a main transformer with a high voltage side connected to the grid and a low voltage side connected to a field circuit converter that feeds a generator field circuit, said static exciter further including a control unit arranged to detect the status of the grid to cause at least a capacitor bank to supply energy to said generator field circuit in case the voltage of the grid falls below a prefixed voltage value, wherein said method comprises:
providing at least one capacitor bank between the low voltage side of the main transformer and the AC side of the field circuit converter.

15. A method according to claim 14, further comprising:
providing the static exciter with a coupling circuit connecting the capacitor bank to connection lines between the low voltage side of the main transformer and the AC side of the field circuit converter.

16. A method for operating a static exciter of an electric generator having a main transformer with a high voltage side connected to the grid and a low voltage side connected to a field circuit converter that feeds a generator field circuit, said static exciter further including a control unit arranged to detect the status of the grid to cause at least a capacitor bank to supply energy to said generator field circuit in case the voltage of the grid falls below a prefixed voltage value, the method comprising:
injecting electric power with the capacitor bank between the low voltage side of the main transformer and the AC side of the field circuit converter.
